(19) United States
(12) Patent Application Publication
(10) Pub. No.: US 2012/0062967 A1
(43) Pub. Date: Mar. 15, 2012

(54) Duplicating diffractive optical elements

(75) Inventors: Michael A. Klug, Austin, TX (US); Qiang Huang, Cedar Park, TX (US)

(73) Assignee: Zebra Imaging, Inc., Austin, TX (US)

(21) Appl. No.: 13/079,811

(22) Filed: Apr. 4, 2011

Related U.S. Application Data
(60) Provisional application No. 61/320,314, filed on Apr. 2, 2010.

(51) Int. Cl. G03H 1/20

(52) U.S. Cl. 359/12

(57) ABSTRACT

Methods and systems for duplicating holograms, including illuminating a master hologram using a first portion of a beam to generate a data beam, recording a copy hologram using a second portion of the beam and the data beam, where the master hologram and the copy hologram are arranged such that the second portion of the beam avoids the master hologram.

### A. PRIORITY

This application claims priority from provisional patent application, 61/320,314, titled “Duplicating Holograms” by M. Klug, filed on 02-APR-2010, which is incorporated herein by reference in its entirety.

This application is related to co-pending patent application titled, “Duplicating Holograms” by M. Klug, filed on 4 Apr. 2011, which is incorporated herein by reference in its entirety.

### B. BACKGROUND

The invention relates generally to the field of duplicating diffractive optical elements.

### C. SUMMARY

In one respect, disclosed are systems, methods, and products for optimizing hologram duplication, including illuminating a first master hologram to generate a first data beam modulated by the first master hologram, recording a first copy hologram using the first data beam and a reference beam, analyzing a light field generated by the first copy hologram, and generating a second master hologram to be used in recording a second copy hologram according to the light field generated and a desired light field.

In one respect, disclosed are systems, methods, and products for duplicating diffractive optical elements, including illuminating a master hologram using a first portion of a beam to generate a data beam, recording a copy hologram using a second portion of the beam and the data beam, where the master hologram and the copy hologram are arranged such that the second portion of the beam avoids the master hologram.

Numerous additional embodiments are also possible.

### D. BRIEF DESCRIPTION OF THE DRAWINGS

Other objects and advantages of the invention may become apparent upon reading the detailed description and upon reference to the accompanying drawings.

FIG. 1 is a diagram illustrating a system for optimizing the duplication, using a single beam, of holograms, diffractive optical elements, holographic optical elements, etc., in accordance with some embodiments.

FIG. 2 is a diagram illustrating a system for optimizing the duplication, using a two beams, of holograms, diffractive optical elements, holographic optical elements, etc., in accordance with some embodiments.

FIG. 3 is a diagram illustrating a system for detecting and analyzing the light field generated by a duplicated hologram, in accordance with some embodiments.

FIG. 4 is a block diagram illustrating a system for duplicating holograms and/or for optimizing the duplication of holograms, in accordance with some embodiments.

FIG. 5 is a diagram illustrating a system for duplicating reflection holograms, in accordance with some embodiments.

FIG. 6 is a diagram illustrating a system for duplicating transmission holograms, in accordance with some embodiments.

FIG. 7 is a diagram illustrating a system for duplicating edge-lit holograms, in accordance with some embodiments.

FIG. 8 is a flow diagram illustrating a method for optimizing the duplication, using a single beam, of holograms, diffractive optical elements, holographic optical elements, etc., in accordance with some embodiments.

FIG. 9 is a flow diagram illustrating a method for duplicating reflection holograms, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### E. Detailed Description

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods for duplicating holograms and for optimizing the duplication of holograms are disclosed. It should be noted that, as used here, the term hologram may generally refer to: traditional/monolithic, “standard” holograms, hogel-based holograms, diffractive optical elements (DOEs), holographic optical elements (HOEs), or generally any other object that can generate a light field when illuminated.

In some embodiments, the methods and systems disclosed enable the tuning/optimization of various properties of the light field generated by the duplicated hologram. In some embodiments, such properties may include: relative diffraction efficiency as a function of proximity to the illumination light source, dispersion angle and/or centroid direction of the diffracted light, chromatic uniformity compensation for dispersive properties of the hologram, etc.

In some embodiments, a copy hologram (H2) may be created from a master hologram (H1). The copy hologram may be them be illuminated at or near the copy hologram's intended working position in order to generated a light field. Illuminance and spectrographic measurements may be made to determine the distribution of light in the generated light field. In some embodiments, one or more cameras may be used to detect and analyze the field generated by the

In some embodiments, a graph may be generated of the generated light field as well as a look-up table of the brightness distribution for the copy hologram. In some embodiments, the generated light field may be compared to a desired light field according to an application of the copy hologram. The generated inverse map may be applied in the form of a “wash” intensity distribution or similar or a more complex texture map.

Accordingly, a new master hologram may be generated using the inverse distribution from above, and a new copy hologram may be created using the new master hologram. In some embodiments, the light field generated using the new copy hologram is closer to the desired light field according to the application of the copy hologram.

In some embodiments, the above optimization/tuning process may be repeated in order to further improve the light field generated by the copy hologram according to the application of the copy hologram. In some embodiments, once an optimized master hologram is generated, additional optimized copy holograms may be easily and effectively created.

In some embodiments, in addition to the optical configuration, a controller may be included and may be configured to adjust the camera angle to detect specific diffracted beam angles. For example, if the hologram, such as a DOE, is to be used to illuminate a front-lit display and the specification calls for a centroid illumination angle that is 15 degrees off normal with a 10 degree spread, the hogel camera angle may be set to 10 degrees and also offset by 15 degrees.

In some embodiments, the system may be configured to create a DOE, particularly (but not exclusively) in edge-lit mode, that can provide uniform diffraction efficiency independent of proximity and angular displacement from the illumination source, and to compensate for other inherent aberrations in diffractive films that may produce unwanted artifacts in their intended function. In the case of a DOE that is to be used as an edge-illuminated front-light element for an active reflective display, the entire display may be illuminated uniformly using a DOE optimized by the disclosed systems and methods, with adequate brightness, and with little or no chromatic dispersion on the edges of the viewzone.

In other embodiments, the systems and methods described here may be configured to enable separation of the hogel plane from the DOE plane, diffuse hogel artifacts, while still enabling a high level of “programmability” of the diffracted light.

In some embodiments, the created holograms may be adapted to enable the illumination of active 2D displays through front-lighting, in very compact, replicable, effective, and efficient ways. In some embodiments, the holograms/DOEs may be used in front-lit reflective displays, such as E-Ink displays, and in applications requiring high quality reproduction of color and high uniformity.

In some embodiments, an edge-lit DOE may be configured to provide a volumetric index modulation to achieve light field generation and control. The inherent directionality of diffraction through such a structure, particularly a relatively thick structure, causes the DOE to be very selective and thus less prone to scatter. In addition, the bulk nature of the DOE may reduce the likelihood of contaminants affecting performance. In addition, the DOEs may be inherently scalable to fit various sizes of displays and various illumination sources.

In some embodiments, systems and methods are disclosed for duplicating or replicating holograms (or generally holograms, DOEs, HOEs, etc.), including reflection, transmission, edge-lit, etc. holograms, in a robust and efficient manner.

In some embodiments, the master (H1) and copy (H2) holograms are mounted in a rigid manner relative to each other to minimize relative motion during the duplication process and thus to increase the quality of the created copy hologram.

In some embodiments, the master and copy holograms are both attached to a rigid frame on the duplicating equipment. An illumination beam may be used such that a first portion of the beam is affected by the master hologram to generate a data beam that is arranged to illuminate the copy hologram. In some embodiments, various types of master holograms may be used such as reflection, transmission, edge-lit, etc. holograms.

In some embodiments, a second portion of the beam (or in some embodiments, a second beam) is used to illuminate the copy hologram. In some embodiments, the first second portion of the beam and the master and copy holograms are arranged in such a way that the second portion of the beam does not pass through the master hologram, thus allowing independent attenuation and general conditioning of the second portion of the beam.

In some embodiments, various types of copy holograms may be generated such as reflection, transmission, edge-lit, etc. holograms.

In some embodiments, the master hologram may be illuminated by introducing a collimated or slightly diverging beam through a window in the rigid frame. The master hologram may be created such that the master hologram produces an image with its “image-plane” or “shear plane” at the opposite side of the block from the master hologram side. The geometry of the master hologram-to-image area may be established such that the image area falls onto the perimeter edge of the beam being used for the master hologram illumination, such that the perimeter component of the illumination beam may be used as the reference beam for a copy hologram. A holographic recording film or equivalent may be placed on a glass surface affixed to the top of the rigid frame, in some embodiments, using index-matching fluid or the material's own adhesion (as is the case for many photopolymers). The structural linking of the master hologram and the copy hologram with using the rigid frame helps ensure minimal vibration sensitivity so that high-speed duplication may be accomplished. A separate attenuator may be used in the perimeter section of the beam to adjust that section of the beam intensity in order to optimize for beam ratios at the duplication plane and maximize diffraction efficiency of the duplicated hologram.

In some embodiments, a mirror surface may be included such that a portion of the illumination/copy beam may reflect from that mirror and be directed to the copy hologram in order to generate a transmission hologram duplicate. In such embodiments, an attenuator may also be employed on that portion of the beam in order to adjust the beam ratios in order to optimize the copy hologram.

In some embodiments, if an edge-lit format copy is desired, two approaches are possible. In the first, a separate reference beam may be introduced into a high-index-matching block, nominally from either side, but preferentially from the opposite side of the master hologram illumination beam introduction. Because this beam is separated from the master hologram illumination beam “upstream”, its intensity may be modulated and an optimal beam ratio can be achieved at the copy hologram duplication position. The likelihood of higher losses and higher energy density requirements for edge-lit duplication, as well as the need to modulate the intensity of the edge-lit reference beam on a fine scale may make it preferable to have a separate beam and shaping optics for this recording format.

In an alternative scheme, the same single diverging beam may be employed for both master hologram illumination and edge-lit reference by employing a small adjustable mirror at the edge of the high-index plinth to couple a portion of the beam into the plinth. Attenuators in both portions of the beam may enable adjustment of beam ratios.

In some embodiments, the systems and methods described here may be configured to replicate holograms with high efficiency, while minimizing artifacts, noise and increasing signal-to-noise traditionally.

In some embodiments, the systems are configured to provide vibration sensitivity, ability to separately adjust reference and image reconstruction beams, ability to accommodate transmission, reflection and edge-lit formats, and ability to reduce image-plane hogel-based artifacts in replicated holograms are some of the problems that are solved using this method and apparatus.

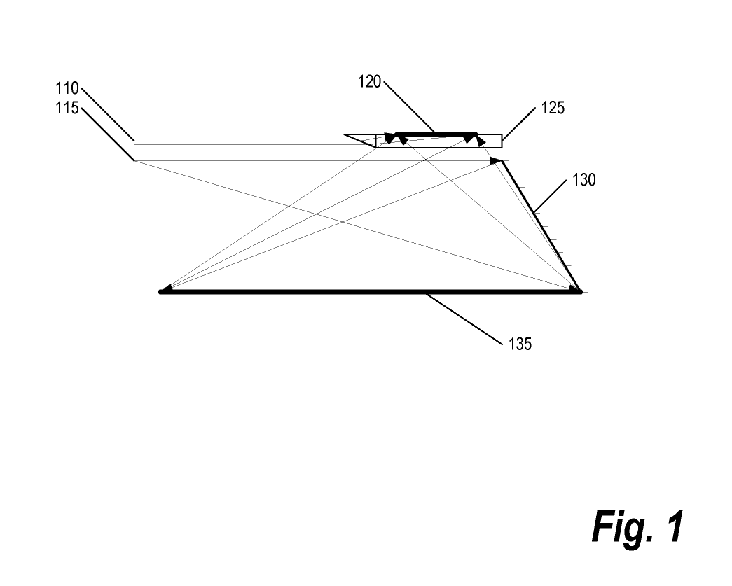

FIG. 1 is a diagram illustrating a system for optimizing the duplication, using a single beam, of holograms, diffractive optical elements, holographic optical elements, etc., in accordance with some embodiments.

In some embodiments, beams 110 and 115 are used to respectively illuminate master hologram 135 and copy hologram 120. In some embodiments, beams 110 and 115 may be portions of the same beam.

In some embodiments, mirror 130 may be used to direct beam 115 towards master hologram 135, which causes a data beam to be created according to master hologram 135 and for the beam to be directed towards copy hologram 120. Optical block 125 is configured to direct beam 110 towards copy hologram 120.

The two beams are configured to interfere and to record an image into copy hologram 120.

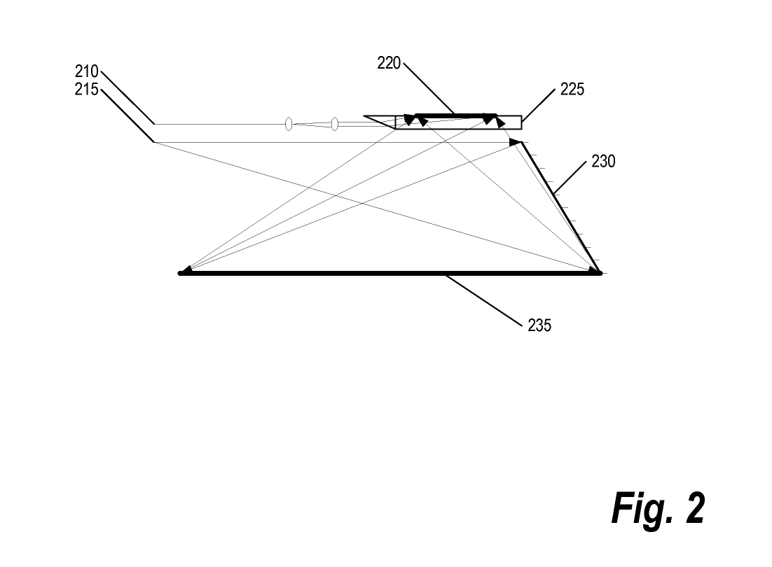

FIG. 2 is a diagram illustrating a system for optimizing the duplication, using a two beams, of holograms, diffractive optical elements, holographic optical elements, etc., in accordance with some embodiments.

In some embodiments, beams 210 and 215 are used to respectively illuminate master hologram 235 and copy hologram 220. In some embodiments, beam 210 may be further collimated.

In some embodiments, mirror 230 may be used to direct beam 215 towards master hologram 235, which causes a data beam to be created according to master hologram 235 and for the beam to be directed towards copy hologram 220. Optical block 225 is configured to direct beam 210 towards copy hologram 220.

The two beams are configured to interfere and to record an image into copy hologram 220.

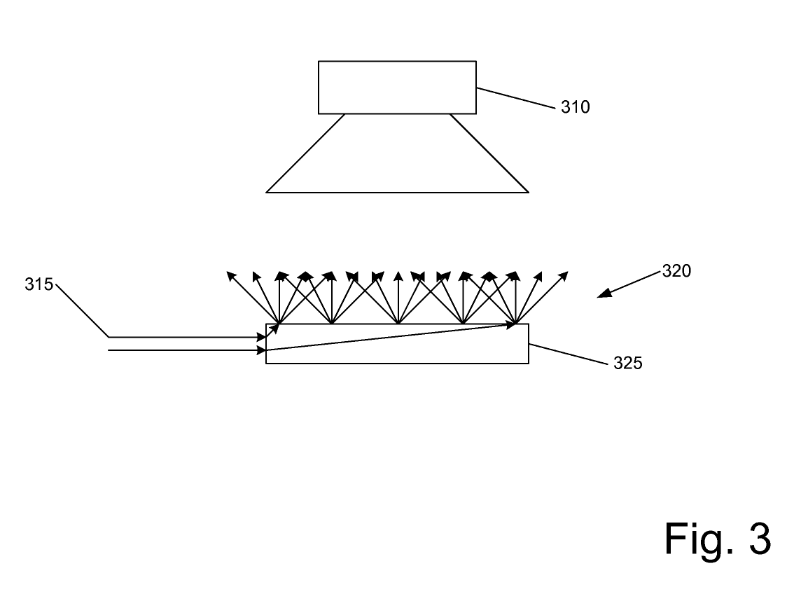

FIG. 3 is a diagram illustrating a system for detecting and analyzing the light field generated by a duplicated hologram, in accordance with some embodiments.

Beams 315 are configured to illuminate copy hologram 325 in copy hologram 325 working configuration. As a result of the illumination, light field 320 is generated in the proximity of copy hologram 325. One or more cameras (such as camera 310) in various positions and orientations are configured to detect and analyze light field 320. In some embodiments, the light field 320 may be compared to a desired light field in order to generate improved master holograms in order to create improved copy holograms as described here.

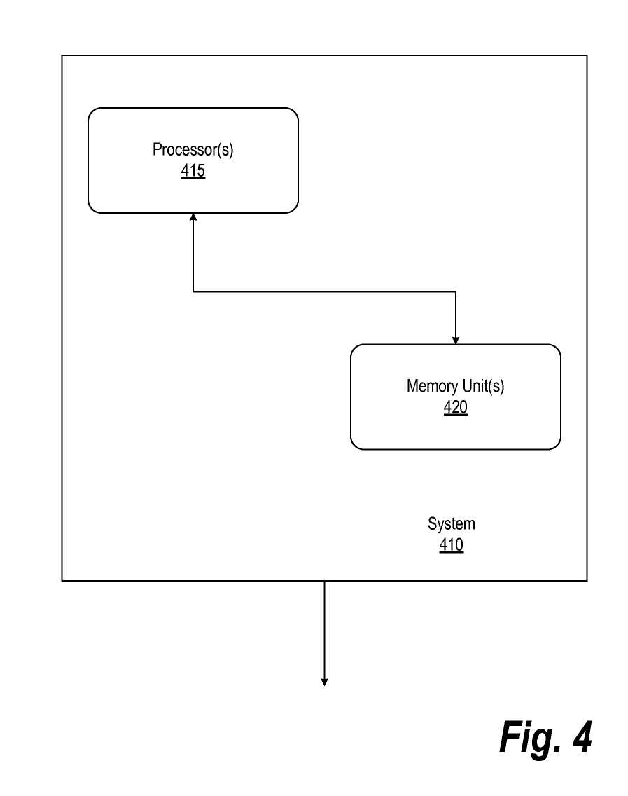

FIG. 4 is a block diagram illustrating a system for duplicating holograms and/or for optimizing the duplication of holograms, in accordance with some embodiments.

System 410 comprises one or more processors 415, which are coupled to one or more memory units 420. In some embodiments, system 410 is configured to perform or assist in the performance of various functions as described here, including but not limited to the optimization of the duplication of holograms and the general duplication of holograms.

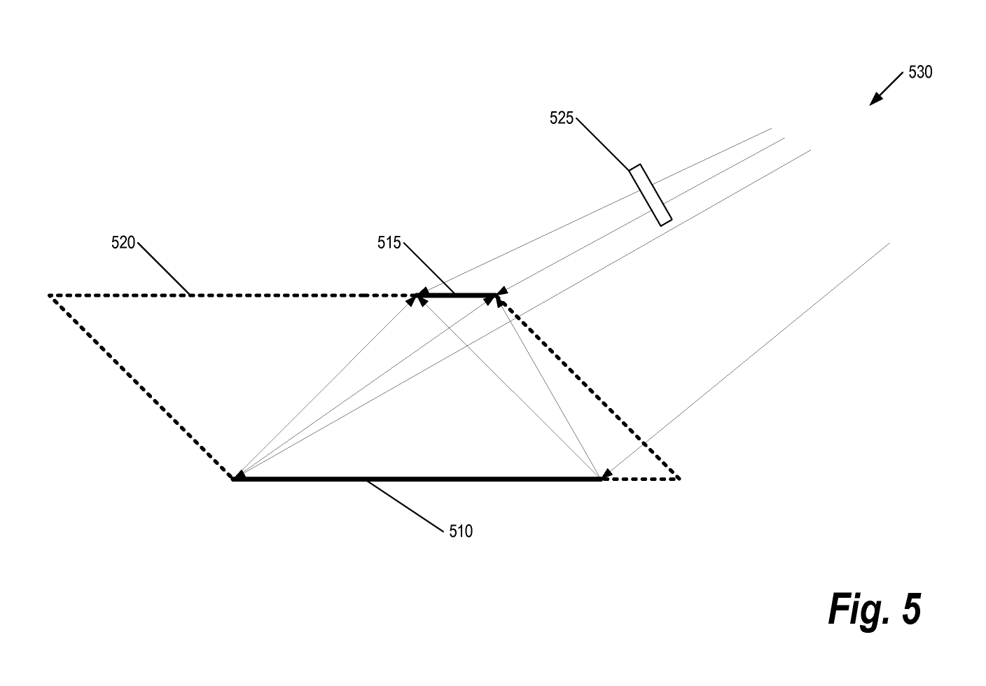

FIG. 5 is a diagram illustrating a system for duplicating reflection holograms, in accordance with some embodiments.

Frame 520 is configured to support master hologram 510 and copy hologram 515 and to keep the two in a rigid position relative to each other.

A first portion of beam 530 is configured to illuminate master hologram 510 in order to generate a data beam directed towards copy hologram 515. A second portion of beam 530 is directed towards copy hologram 515. The second portion of the beam interferes with the data beam to record an image in copy hologram 515, which is configured as a reflection hologram.

Attenuator 525 is configured to control attenuation to the second portion of beam 530 in order to optimize the recording of the image in copy hologram 515.

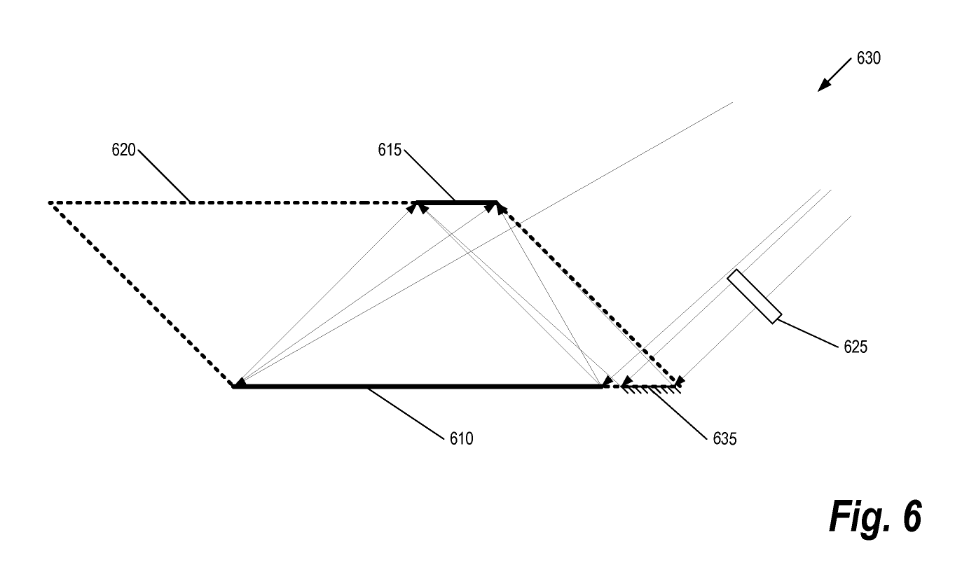

FIG. 6 is a diagram illustrating a system for duplicating transmission holograms, in accordance with some embodiments.

Frame 620 is configured to support master hologram 610 and copy hologram 615 and to keep the two in a rigid position relative to each other.

A first portion of beam 630 is configured to illuminate master hologram 610 in order to generate a data beam directed towards copy hologram 615. A second portion of beam 630 is directed towards copy hologram 615 using mirror 635. The second portion of the beam interferes with the data beam to record an image in copy hologram 615, which is configured as a transmission hologram.

Attenuator 625 is configured to control attenuation to the second portion of beam 630 in order to optimize the recording of the image in copy hologram 615.

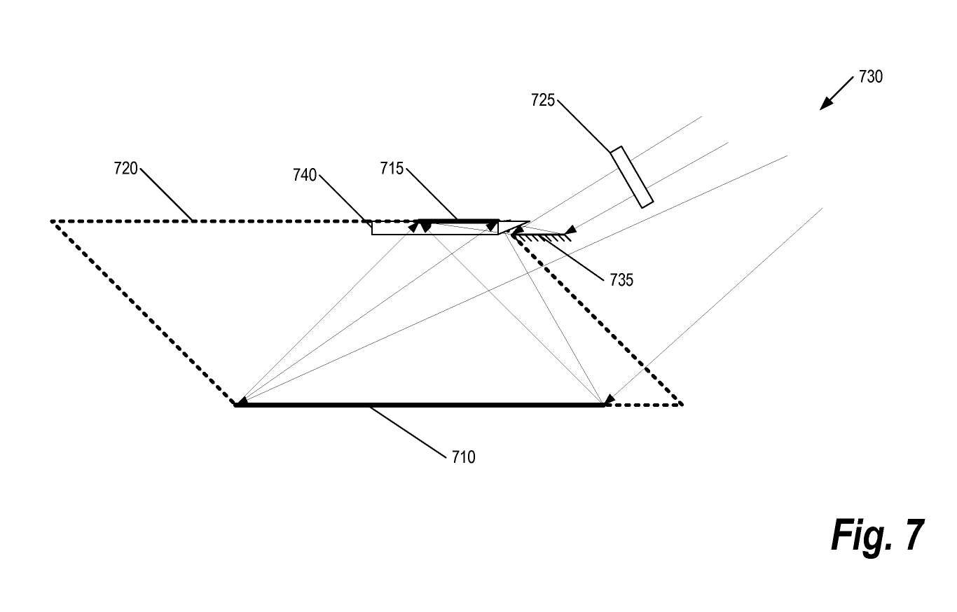

FIG. 7 is a diagram illustrating a system for duplicating edge-lit holograms, in accordance with some embodiments.

Frame 720 is configured to support master hologram 710 and copy hologram 715 and to keep the two in a rigid position relative to each other.

A first portion of beam 730 is configured to illuminate master hologram 710 in order to generate a data beam directed towards copy hologram 715. A second portion of beam 730 is directed towards copy hologram 715 using mirror 735 and optical block 740. The second portion of the beam interferes with the data beam to record an image in copy hologram 715, which is configured as an edge-lit hologram.

Attenuator 725 is configured to control attenuation to the second portion of beam 730 in order to optimize the recording of the image in copy hologram 715.

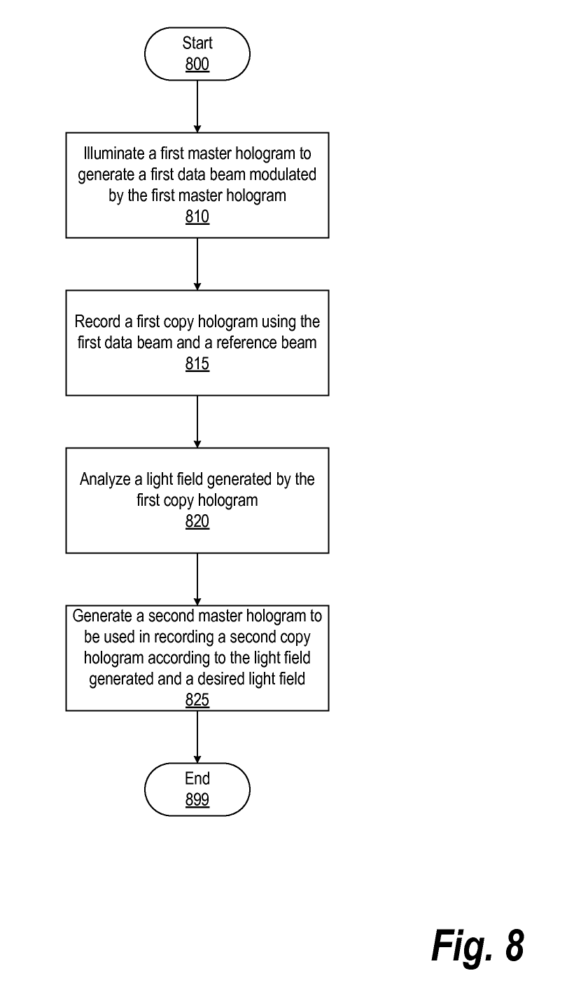

FIG. 8 is a flow diagram illustrating a method for optimizing the duplication, using a single beam, of holograms, diffractive optical elements, holographic optical elements, etc., in accordance with some embodiments.

The method described may be performed by any of the system described in FIGS. 1-7.

Processing begins at 800 where, at block 810 a first master hologram is illuminated to generate a first data beam modulated by the first master hologram.

At block 820, a first copy hologram is recorded using the first data beam and a reference beam.

At block 820, a light field generated by the first copy hologram is analyzed.

At block 825, a second master hologram is generated to be used in recording a second copy hologram according to the light field generated and a desired light field.

Processing subsequently ends at 899.

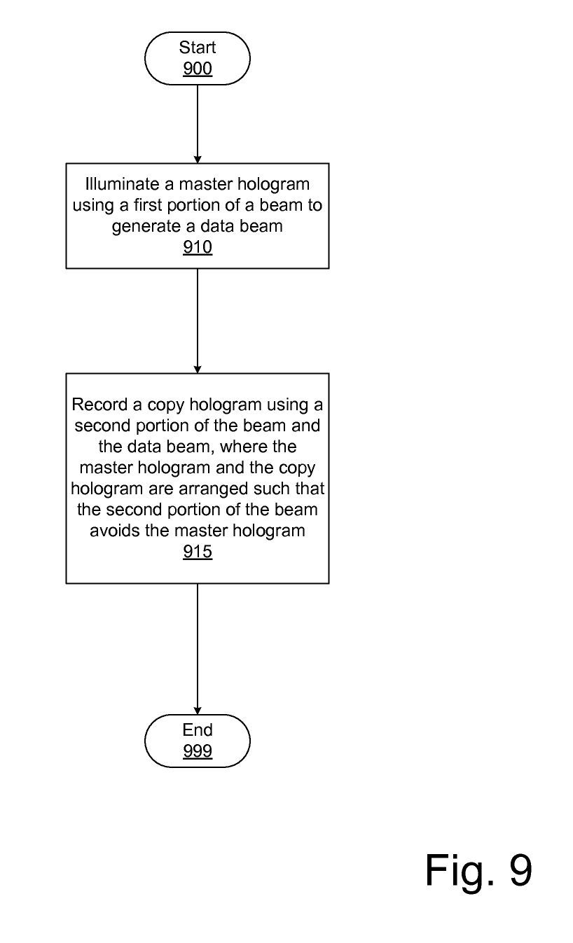

FIG. 9 is a flow diagram illustrating a method for duplicating reflection holograms, in accordance with some embodiments.

The method described may be performed by any of the system described in FIGS. 1-7.

Processing begins at 900 where, at block 910, a master hologram is illuminated using a first portion of a beam to generate a data beam.

At block 915, a copy hologram is recorded using a second portion of the beam and the data beam, where the master hologram and the copy hologram are arranged such that the second portion of the beam avoids the master hologram.

Processing subsequently ends at 999.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for duplicating diffractive optical elements, the method comprising:
illuminating a master hologram using a first portion of a beam to generate a data beam;
recording a copy hologram using a second portion of the beam and the data beam, where the master hologram and the copy hologram are arranged such that the second portion of the beam avoids the master hologram.

2. The method of claim 1, where the master hologram and copy hologram are rigidly supported relative to each other.

3. The method of claim 1, further comprising attenuating the first portion of the beam.

4. The method of claim 1, further comprising attenuating the second portion of the beam.

5. The method of claim 1, where the master hologram is at least one of reflection hologram, transmission hologram, and edge-lit hologram.

6. The method of claim 1, where the copy hologram is at least one of reflection hologram, transmission hologram, and edge-lit hologram.

7. A system for duplicating optical elements, the system comprising:
one or more processors;
one or more memory units coupled to the one or more processors;
the system being configured to:
illuminate a master hologram using a first portion of a beam to generate a data beam;
record a copy hologram using a second portion of the beam and the data beam, where the master hologram and the copy hologram are arranged such that the second portion of the beam avoids the master hologram.

8. The system of claim 7, where the master hologram and copy hologram are rigidly supported relative to each other.

9. The system of claim 7, further comprising attenuating the first portion of the beam.

10. The system of claim 7, further comprising attenuating the second portion of the beam.

11. The system of claim 7, where the master hologram is at least one of reflection hologram, transmission hologram, and edge-lit hologram.

12. The system of claim 7, where the copy hologram is at least one of reflection hologram, transmission hologram, and edge-lit hologram.

13. A computer program product embodied in a computer-operable medium, the computer program product comprising logic instructions, the logic instructions being effective to:
illuminate a master hologram using a first portion of a beam to generate a data beam;
record a copy hologram using a second portion of the beam and the data beam, where the master hologram and the copy hologram are arranged such that the second portion of the beam avoids the master hologram.

14. The product of claim 13, where the master hologram and copy hologram are rigidly supported relative to each other.

15. The product of claim 13, further comprising attenuating the first portion of the beam.

16. The product of claim 13, further comprising attenuating the second portion of the beam.

17. The product of claim 13, where the master hologram is at least one of reflection hologram, transmission hologram, and edge-lit hologram.

18. The product of claim 13, where the copy hologram is at least one of reflection hologram, transmission hologram, and edge-lit hologram.
